(19) United States
(12) Patent Application Publication
(10) Pub. No.: US 2012/0279480 A1
(43) Pub. Date: Nov. 8, 2012

(54) METHOD FOR FLUSHING AN ACTIVATED CARBON FILTER

(76) Inventor: Ernst Wild, Oberriexingen (DE)

(21) Appl. No.: 13/503,107

(22) PCT Filed: Oct. 29, 2010
(86) PCT No.: PCT/EP2010/066460

§ 371 Date: Jul. 25, 2012

(30) Foreign Application Priority Data
Oct. 30, 2009 (DE) 10 2009 046 237.6

(51) Int. Cl. F02M 33/02

(52) U.S. Cl. 123/520

(57) ABSTRACT

In a method for flushing an activated carbon filter of a tank ventilation system of an internal combustion engine, which tank ventilation system includes a fuel tank and an activated carbon filter with which a tank shut-off valve TAV, a fuel tank vent valve TEV, and an activated carbon filter shut-off valve AAV are associated, the tank shut-off valve TAV is closed, the fuel tank vent valve TEV is opened, and the activated carbon filter shut-off valve AAV is closed. The activated carbon filter shut-off valve AAV is controlled to close in a clocked manner.

### BACKGROUND OF THE INVENTION

1. Field of the Invention

The present invention relates to a method for flushing an activated carbon filter of a tank ventilation system of an internal combustion engine.

2. Description of Related Art

Fuel vapors occur in the fuel tank of motor vehicles. To avoid emissions of these volatile hydrocarbons from the tank, today's motor vehicles are provided with devices for capturing the fuel vapors. An activated carbon filter is typically provided for this purpose. A vent line of the fuel tank opens into this activated carbon filter. The activated carbon adsorbs the fuel vapors, i.e., the volatile hydrocarbons. Another line leads from the activated carbon filter to the intake manifold of the engine, i.e., the internal combustion engine. A fuel tank vent valve (TEV) is situated in this line. The activated carbon filter is regenerated, i.e., flushed, by opening the fuel tank vent valve, resulting in a fluid connection between the activated carbon filter and the intake manifold. An air ventilation opening or an air ventilation line of the activated carbon filter is in contact with the ambient air. When the fuel tank vent valve is open and the engine is operating, fresh air is drawn in through the activated carbon via the air ventilation line due to the negative pressure prevailing in the intake manifold. The fresh air entrains the adsorbed fuel in the flushing flow and supplies it to the combustion engine. The activated carbon filter remains absorptive for newly evaporating fuel as the result of routinely flushing, i.e., regenerating, the activated carbon.

To allow the leak-tightness of the overall tank system to be checked, an activated carbon filter shut-off valve (AAV) is often provided at the outlet of the vent line of the activated carbon filter. The leak-tightness is checked by closing the AAV and opening the TEV. Due to the negative pressure prevailing in the intake manifold, a negative pressure develops in the overall tank system which is detectable via a differential pressure sensor installed in the fuel tank. The TEV is closed when the negative pressure has reached a certain threshold. The negative pressure is maintained with the AAV closed and the TEV closed, provided that the required leak-tightness of the tank system is present.

An activated carbon filter has only a limited intake capacity. When the intake capacity, i.e., the storage capacity, of the activated carbon filter is used up, fuel drips from the activated carbon filter. This problem occurs in particular when the engine is switched off, for example for vehicles having a hybrid drive, in which the internal combustion engine is switched off during electric mode operation. The object of the present invention, therefore, is to improve the flushing and regeneration of the activated carbon filter in order to provide a maximum intake capacity of the activated carbon filter.

### BRIEF SUMMARY OF THE INVENTION

The method according to the present invention is used for flushing an activated carbon filter of a tank ventilation system of an internal combustion engine having a fuel tank. A tank shut-off valve (TAV), a fuel tank vent valve (TEV), and an activated carbon filter shut-off valve (AAV) are associated with the activated carbon filter. According to the present invention, very intensive and rapid flushing of the activated carbon filter is achieved by applying a very high negative pressure to the activated carbon filter. The negative pressure in the activated carbon filter is set by opening the TEV and closing the AAV. The TAV is preferably closed to prevent the very low pressure from continuing to the tank and possibly causing fuel to be suctioned out there. After setting the negative pressure, in order to maintain the negative pressure and for intensive flushing the AAV may be controlled to close in a clocked manner. For setting the negative pressure, the TEV is preferably opened in a ramp-like manner until a predefinable proportion of fuel in the flushing flow has resulted. The AAV is subsequently closed in a ramp-like manner until a predefinable negative pressure and/or a predefinable outgassing from the activated carbon filter has/have resulted. The valves are preferably controlled by including the lambda regulation, on the basis of which the mass flows, i.e., the proportion of fuel in the flushing flow, may be ascertained. Appropriate pressure sensors may be provided for detecting the pressure in the activated carbon filter.

As a result of the very low pressure in the activated carbon filter which is settable in the method according to the present invention, the activated carbon releases the stored fuel vapor, i.e., the adsorbed hydrocarbons, much more effectively and quickly than in conventional flushing of an activated carbon filter. By using the method according to the present invention, the maximum storage capacity of the activated carbon filter, which is necessary, for example, in the shutoff phase of the combustion engine in a vehicle having a hybrid drive, may thus be provided again very quickly.

The flushing may be terminated by reopening the AAV, causing the negative pressure to subside. The AAV may be opened, for example, when the proportion of fuel in the flushing flow, which is detectable via a lambda regulation, for example, drops below a predefinable threshold.

The intensive flushing may also be terminated by opening the TAV. The TAV may be opened, for example, when the pressure in the fuel tank exceeds a predefinable threshold, i.e., when fuel vapors are increasingly generated. As a result of opening the TAV, the fuel vapors pass to the activated carbon filter, where they are captured and absorbed.

According to the method according to the present invention, the flushing, and in particular the intensive flushing, is preferably carried out during predefinable operating phases of the internal combustion engine, in particular during partial load operation. Carrying out the flushing during partial load operation ensures smooth running of the engine and a sufficient pressure drop for carrying out the method according to the present invention. The method according to the present invention may be carried out at predefinable time intervals, or as needed. The need may be determined, for example, on the basis of the degree of filling of the activated carbon filter.

With the aid of the method according to the present invention, the regeneration of the activated carbon may be controlled significantly better in comparison to conventional flushing methods. When the concentration of hydrocarbons in the flushing flow is low, the hydrocarbons remaining in the activated carbon may be released much more quickly as a result of the applied negative pressure. However, for higher hydrocarbon concentrations in the flushing flow the negative pressure may have an adverse effect. An excessively high proportion of fuel in the flushing flow may result in rough running of the engine, in particular in idle mode, since the hydrocarbon vapor may be unevenly distributed over the cylinders. This is taken into account according to the present invention in that the hydrocarbon content in the flushing flow is detected with the aid of the lambda regulation, for example, and the TEV is appropriately controlled. Accordingly, the TEV is opened to a lesser degree when there is an increase in the hydrocarbon concentration in the flushing flow. However, since the operation of the TEV is inaccurate at very small flow rates, in this case negative pressure is preferably not applied; i.e., the AAV is not closed.

Furthermore, the present invention includes a computer program which executes all steps of the described method when the computer program runs on a computer or a control unit. Lastly, the present invention includes a computer program product having program code, which is stored on a machine-readable carrier, for carrying out the method according to the present invention when the program runs on a computer or a control unit. With the aid of the computer program and the computer program product, the method according to the present invention is implementable, for example, in existing vehicles without the need for installing additional components.

### BRIEF DESCRIPTION OF THE DRAWINGS

FIG. 1 shows a schematic illustration of a tank ventilation system of an internal combustion engine for carrying out the method according to the present invention.

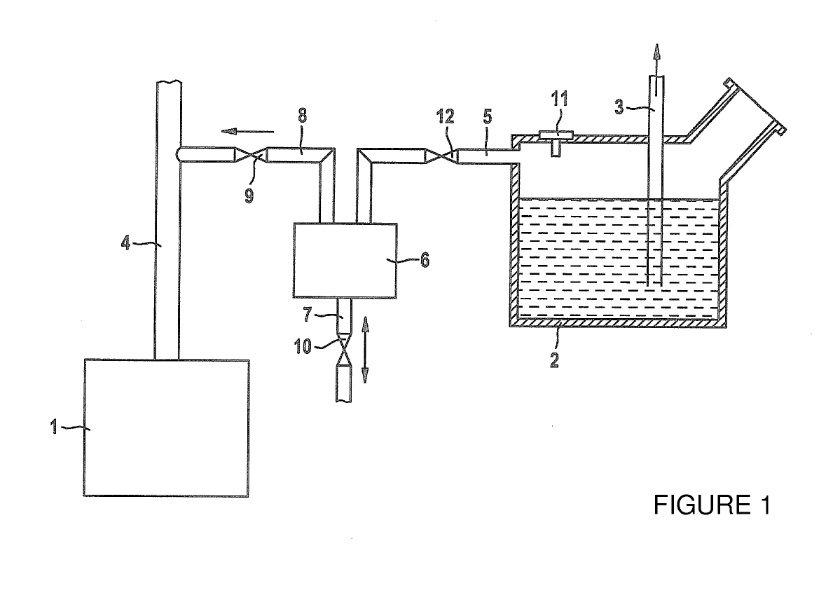

### DETAILED DESCRIPTION OF THE INVENTION

The FIGURE shows the tank ventilation system, i.e., the tank ventilation system of an internal combustion engine 1. Liquid fuel, which partially goes into the gaseous phase by evaporation, is stored in a fuel tank 2. For withdrawing the liquid fuel from fuel tank 2 a withdrawal line 3 is provided, through which the fuel is supplied to intake manifold 4 of combustion engine 1 in a known manner (not illustrated). The fuel vapors generated in fuel tank 2 are supplied to an activated carbon filter 6 via vent pipe 5. The volatile hydrocarbons are adsorbed onto the activated carbon inside filter 6. Activated carbon filter 6 is connected to the ambient air via an air ventilation line 7. Another line 8 connects activated carbon filter 6 to intake manifold 4. A fuel tank vent valve TEV 9 is provided in line 8. In conventional flushing of activated carbon filter 6, TEV 9 is opened while the engine is operating. Fresh air is thus drawn in through activated carbon filter 6 via air ventilation line 7 as the result of the negative pressure prevailing in the intake manifold. The fresh air entrains hydrocarbons adsorbed onto the activated carbon and conducts them via line 8 to intake manifold 4 for combustion inside internal combustion engine 1.

An activated carbon filter shut-off valve AAV 10 is provided in air ventilation line 7. AAV 10 together with a differential pressure sensor 11 in fuel tank 2 is customarily used to check the leak-tightness of the tank ventilation system. These components, together with a further valve in vent pipe 5, tank shut-off valve TAV 12, are used for the method according to the present invention to achieve intensive flushing of activated carbon filter 6. The intensive flushing according to the present invention is preferably carried out in operating phases of internal combustion engine 1 in which supplying fairly large quantities of fuel vapors does not adversely affect the operation of the internal combustion engine, for example during partial load operation. At the beginning of the flushing, TEV 9 is initially opened in a ramp-like manner. AAV 10 is closed in a ramp-like manner, resulting in a low pressure in activated carbon filter 6. TAV 12 is closed to prevent the very low pressure in activated carbon filter 6 from continuing to fuel tank 2. To maintain the low pressure in activated carbon filter 6, AAV 10 is controlled in a clocked manner for the intensive flushing.

The negative pressure may be set by carrying out the following steps:

After start-up, with the lambda regulation operationally ready, the flushing rate (ratetes) is increased from zero in a ramp-like manner:

ratetes_new=ratetes_old+delta.

The flushing flow (mstev) flowing through TEV 9 is computed as follows:

mstev=ratetes*msdk,

where msdk describes the mass flow through a throttle valve of the internal combustion engine, which is detectable using a hot film air mass flow meter, for example.

The control pulse duty factor (tatesetpoint) is computed from the flushing flow as follows:

tatesetpoint=inverse of the valve characteristic curve (flushing flow).

The proportion of fuel (fucote) in the flushing flow may be computed from the correction factor of the lambda regulation (fr) as follows:

fucote=(1−fr)/(16*ratetes).

When the maximum proportion of fuel of the flushing flow in relation to the total fuel reaches a predefinable or allowable limit, the flushing rate is maintained; i.e., TEV 9 is not opened further. TEV 9 is opened further, provided that the allowable limit has not yet been reached. As a result of the ramp-like closing of AAV 10 with TAV 12 closed, intensive flushing of activated carbon filter 6 then occurs, since the pressure in activated carbon filter 6 drops further due to the ramp-like closing of AAV 10. This causes the hydrocarbons adsorbed in activated carbon filter 6 to be increasingly released. The ramp-like closing of AAV 10 is stopped as soon as a predefinable or maximum negative pressure has developed in activated carbon filter 6, or until a maximum of the outgassing fuel is reached. The intensive flushing may be continued by controlling AAV 10 in a clocked manner. If the computed proportion of fuel in the flushing flow drops below a predefinable threshold, the intensive flushing may be terminated by opening AAV 10. An appropriate pressure measuring means may be provided for detecting the pressure in activated carbon filter 6.

The opening of TAV 12 may be controlled via the pressure prevailing in tank 2. If the pressure exerted by the fuel vapors in fuel tank 2 during the flushing operation exceeds a predefinable threshold, TAV 12 may be opened, so that fuel vapors pass to activated carbon filter 6 and the intensive flushing is terminated. At the next opportunity, after the pressure in activated carbon filter 6 has dropped again, flushing may once again be carried out in the described manner. If the pressure threshold in tank 2 has not been reached, TAV 12 remains closed and no further flushing is necessary, since fuel vapors are not able to reach the already flushed activated carbon filter 6. The pressure in the fuel tank is preferably measured with the aid of differential pressure sensor 11.

The flushing of activated carbon filter 6 in the described manner may be carried out at regular intervals, for example at predetermined times and/or during predefined operating phases of engine 1. In other specific embodiments, or in addition thereto, the described flushing may be carried out according to the need, which is ascertained, for example, based on the filling level of activated carbon filter 6.

The intensive flushing of activated carbon filter 6 according to the present invention is preferably carried out at a low fuel concentration in the flushing flow. At a high fuel concentration in the flushing flow the applied negative pressure could have an adverse effect, since an excessively high proportion of fuel may result in rough running of the engine, in particular in idle mode.

The method according to the present invention for flushing an activated carbon filter is particularly suited for applications which require a maximum storage capacity of the activated carbon filter. These involve in particular applications in which the internal combustion engine is sometimes switched off, for example in start/stop systems, or in vehicles having a hybrid drive. The generated fuel vapor is conducted to the activated carbon filter during periods when the internal combustion engine is switched off. As soon as the intake capacity of the activated carbon is used up, fuel drips from the activated carbon filter. As a result of the intensive flushing of the activated carbon filter according to the present invention, optimal use is made of the storage capacity of the activated carbon filter; in this regard the existing valves and lines may be used. The method according to the present invention is preferably implementable as a computer program, for example in the control unit of a motor vehicle. Since the device components, i.e., in particular the various valves, needed for carrying out the method according to the present invention are often already present in the motor vehicle, the method according to the present invention may be easily applied by running the appropriate computer program on, for example, the engine control unit in a motor vehicle.

1-7. (canceled)

8. A method for flushing an activated carbon filter of a tank ventilation system of an internal combustion engine having a fuel tank, a tank shut-off valve, a fuel tank vent valve, and an activated carbon filter shut-off valve associated with the activated carbon filter, comprising:
closing the tank shut-off valve;
opening the fuel tank vent valve; and
closing the activated carbon filter shut-off valve.

9. The method as recited in claim 8, wherein for setting a negative pressure, when the activated carbon filter shut-off valve is open the fuel tank vent valve is initially opened in a ramp-like manner until a predefined proportion of fuel in a flushing flow results, and subsequently the activated carbon filter shut-off valve is closed in a ramp-like manner until at least one of a predefined negative pressure and a predefined out-gassing from the activated carbon filter results.

10. The method as recited in claim 9, wherein after setting the negative pressure, the activated carbon filter shut-off valve is controlled to close in a clocked manner.

11. The method as recited in claim 8, wherein the flushing is terminated by opening the activated carbon filter shut-off valve.

12. The method as recited in claim 11, wherein the flushing is carried out during partial load operation of the internal combustion engine.

13. A non-transitory computer-readable data storage medium storing a computer program having program codes which, when executed on a computer, performs a method for flushing an activated carbon filter of a tank ventilation system of an internal combustion engine having a fuel tank, a tank shut-off valve, a fuel tank vent valve, and an activated carbon filter shut-off valve associated with the activated carbon filter, the method comprising:
closing the tank shut-off valve;
opening the fuel tank vent valve; and
closing the activated carbon filter shut-off valve.
